(19) United States
(12) Patent Application Publication
(10) Pub. No.: US 2012/0311100 A1
(43) Pub. Date: Dec. 6, 2012

(54) SYSTEM AND METHOD FOR DISPLAYING CONTENTS BASED ON SEAMLESS INFORMATION

(75) Inventors: Young-suk KIM, Seoul (KR); Ji-hoon KIM, Seoul (KR); Kyong-hyang CHOI, Seoul (KR); Tae-sook HA, Anyang-si (KR)

(73) Assignee: KT CORPORATION, Seongnam (KR)

(21) Appl. No.: 13/487,910

(22) Filed: Jun. 4, 2012

(30) Foreign Application Priority Data
Jun. 3, 2011 (KR) 10-2011-0053626

(51) Int. Cl. G06F 15/16

(52) U.S. Cl. 709/219

(57) ABSTRACT

A method for displaying contents based on seamless information is provided. The method includes receiving display history information of multimedia contents, including stop information indicating a stop location in the multimedia contents, from one of a plurality of devices, generating seamless information about the multimedia contents based on the display history information of the multimedia contents, and transmitting the generated seamless information to one or more of the plurality of devices, where the devices that received the transmitted seamless information store the seamless information and one of the devices displays the multimedia contents based on the stored seamless information.

### CROSS-REFERENCE TO RELATED APPLICATION

This application claims priority from the Korean Patent Application No. 10-2011-0053626, filed on Jun. 3, 2011 in the Korean Intellectual Property Office, the disclosure of which is incorporated herein by reference in its entirety.

### BACKGROUND

1. Field

Exemplary embodiments relate to a system and a method for displaying contents based on seamless information, and in particular, to a system and a method for displaying the contents among a plurality of devices.

2. Description of the Related Art

As digital technologies are developed, the demarcation in technical fields becomes blurred. Through integration of technologies in various technical fields, devices or services in a new form have been developed. For example, a conventional mobile device has provided services to make calls and transmit messages. However, a recent mobile device has various functions such as playing music, radio, reproducing videos and digital multimedia broadcasting (DMB), and furthermore, is capable of providing network connection using radio communication.

Devices capable of using multimedia contents such as mobile devices, tablet PCs, laptops, and TVs are widely used. Information communication technologies using wired and wireless networks are developed. Under the circumstances, there is a need for a service to use multimedia contents in cooperation with various devices retained by a user, as well as multimedia contents through one device.

With the need for the service to use contents among various devices, a technology for communication of contents among devices has been researched. Especially, an N screen means a service to use common contents in various devices such as TVs, PCs, tablet PCs, and smart phones.

Korean and foreign mobile communication service providers expect that with the increase of time when users use services provided by the mobile communication service providers through the N screen, possibility that the users would purchase contents such as movies and dramas increases, thereby, eventually possibility of sales of the contents increases. Thus, the mobile communication service providers perceive that the N screen will be a future promising service.

For example, in case of using the N screen, a user may enjoy specific movies, music, or games, which are purchased from an App store of a smart phone using the smart phone outside the house. When the user comes into home, he/she may view the same contents seamlessly through a TV or a PC.

The N screen is advantageous in that since contents purchased by a user are stored in a server, and not a device, the contents can be loaded and used in various devices at any time and in any place.

In the N screen, however, in the event that a device that a user attempts to use cannot be easily connected to a server, the contents stored in the server cannot be loaded. Thus, it would be difficult to provide a seamless service of contents among devices.

### SUMMARY

In order to address the above-described problems, an exemplary embodiment provides a system and a method for displaying contents based on seamless information, which are capable of providing a seamless service of identical multimedia contents among a plurality of devices retained by a user.

An exemplary embodiment also provides a system and a method for displaying contents based on seamless information, in which when a device of a user could not be connected to a network, a seamless service of multimedia contents can be provided without connection to a server.

A method of providing a seamless multimedia contents service, the method includes receiving by a content server from one of a plurality of devices display history information related to multimedia contents, including stop information indicating a stop location in the multimedia contents, generating seamless information about the multimedia contents based on the display history information, and transmitting the generated seamless information to at least one of the plurality of devices, where the at least one of the plurality of devices that received the transmitted seamless information stores the seamless information and where the at least one of the plurality of devices displays the multimedia contents based on the stored seamless information.

A content server for providing a seamless service of multimedia contents, the content server includes a user device management unit configured to manage information on a user and information on a plurality of devices that belong to the user, a content management unit configured to manage information on multimedia contents obtained by the user, a seamless information generation unit configured to generate seamless information about the multimedia contents based on display history information comprising stop information indicating a stop location in the multimedia contents received from one of the plurality of devices, and a device communication unit configured to transmit the seamless information to the plurality of devices and configured to receive the display history information from the one of the plurality of devices, where the seamless information is stored in the plurality of devices, and one of the plurality of devices displays the multimedia contents based on the stored seamless information.

A device for displaying multimedia contents, the device includes a content display unit configured to display one of a plurality of multimedia contents obtained by a user, a display history information generation unit, configured to generate display history information on the multimedia contents based on a stopped location in displaying the multimedia contents, a communication unit configured to transmit the generated display history information to a content server and configured to receive seamless information from the content server, and a controller configured to match the seamless information with the multimedia contents, where the content display unit displays the multimedia contents based on the received seamless information received by the communication unit.

It is possible to provide a seamless service of identical multimedia contents among a plurality of devices.

Even in the case where a device of a user is not connected to a network, it is possible to use multimedia contents based on seamless information. Since the contents based on seamless information can be provided without connection to a server, it is possible to offer convenience to a user.

### BRIEF DESCRIPTION OF THE DRAWINGS

Non-limiting and non-exhaustive exemplary embodiments will be described in conjunction with the accompanying drawings. Understanding that these drawings depict only several exemplary embodiments in accordance with the disclosure and are, therefore, not intended to limit its scope, the disclosure will be described with specificity and detail through use of the accompanying drawings, in which:

FIG. 1 is a configuration view illustrating a system for displaying contents based on seamless information in accordance with an exemplary embodiment;

FIG. 2 is a detailed configuration view illustrating a configuration of a server for displaying contents based on seamless information in accordance with an exemplary embodiment;

FIG. 3 is a detailed configuration view illustrating a configuration of a device for displaying contents based on seamless information in accordance with an exemplary embodiment;

FIG. 4 is a view illustrating an a management table for seamless information about the multimedia contents in a system for displaying contents based on seamless information in accordance with an exemplary embodiment; and

FIG. 5 is a flow chart illustrating a method of displaying contents based on seamless information in accordance with an exemplary embodiment.

### DETAILED DESCRIPTION OF EXEMPLARY EMBODIMENTS

Hereinafter, exemplary embodiments will be described in detail with reference to the accompanying drawings so that the present inventive concept may be readily implemented by those skilled in the art. However, it is to be noted that the present disclosure is not limited to the exemplary embodiments, but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

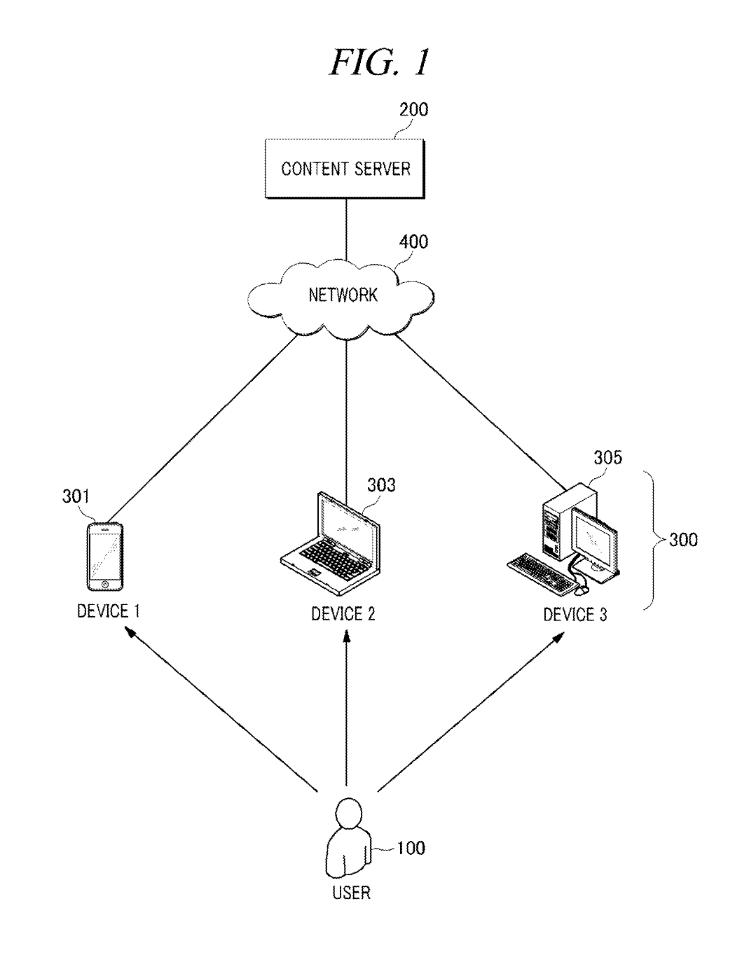

FIG. 1 is a configuration view illustrating a system for displaying contents based on seamless information in accordance with an exemplary embodiment.

As illustrated in FIG. 1, a system for displaying contents based on seamless information in accordance with an exemplary embodiment includes a plurality of devices 300 retained by a user 100, and a content server 200. Examples of the devices 300 may be a personal computer, a laptop, a cellular telephone, a tablet, a television, and so on. The server 200 includes a hardware processor and a memory and may be connected to one or more remote databases.

Each of the plurality of devices 300 retained by the user 100, i.e., devices 301, 303, and 305 can be connected to the content server 200 through a network 400. Here, the network 400 may include a wired or a wireless network.

The user 100 may be provided with multimedia contents from one of the plurality of devices 300

The content server 200 may receive display history information on the multimedia contents which may be generated when the display of the multimedia contents is stopped from the plurality of devices 300. Based on the received display history information on the multimedia contents, the content server 200 may generate seamless information about the multimedia contents and transmit the information to the plurality of devices 300 to update seamless information.

Accordingly, the user 100 can be provided with the seamless service of the multimedia contents without connection to the content server 200, since the plurality of devices 300 have already stored the seamless information about the multimedia contents from the content server 200.

For example, when the device 1 301 reproduces video contents retained by the user 100 and then the reproduction of the video contents is stopped, the device 301 may generate display history information on the video contents and transmit the information to the content server 200. Based on the received display history information from the device 1 301, the content server 200 may generate seamless information about the video contents, and transmit the generated seamless information to all or a part of the plurality of devices 300 to update the seamless information about the video contents. In this case, the device 1 301 may receive a message indicating the completion of the update of the seamless information from the content server 200.

Thereafter, when one of the plurality of the devices 300 (the device 1 301, or the device 2 303, or the device 3 305) reproduces the video contents, one of the plurality of the devices (the device 1 301, or the device 2 303 or the device 3 305) may provide the seamless service of the video contents by using the seamless information that has been received and updated from the content server 200, without having a connection to the content server 200.

Accordingly, the user 100 can seamlessly watch the video contents on the one of the devices 300 from a time point, at which reproduction of the video contents are stopped on the device 1 301. The user 100 may be provided with the seamless service without connecting to the content server 200 in order to seamlessly watch the video contents.

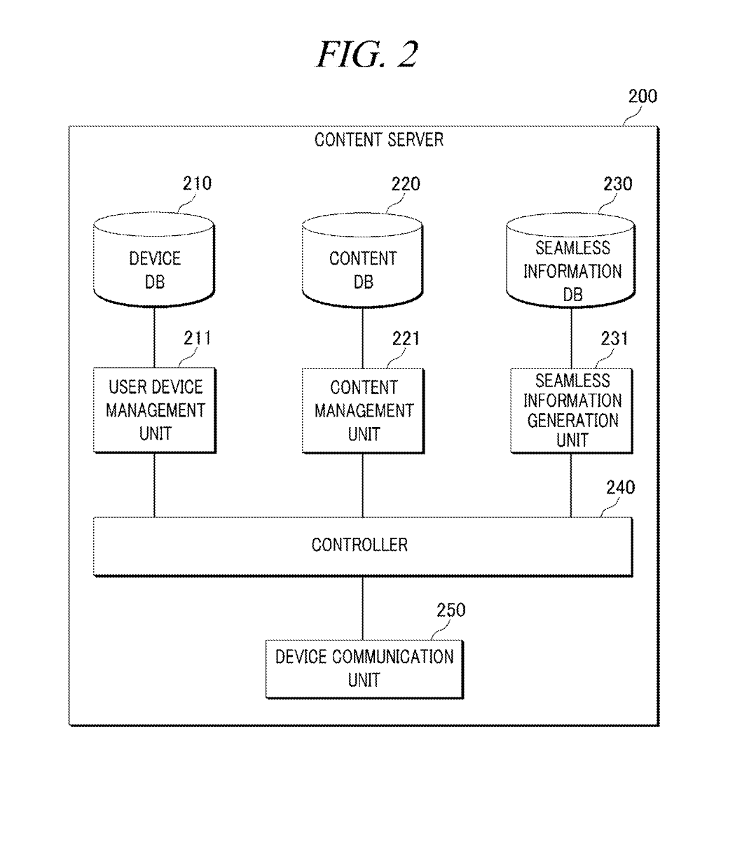

FIG. 2 is a configuration view illustrating the configuration of a server for displaying contents based on seamless information in accordance with an exemplary embodiment.

With reference to FIG. 2, a content server 200 for displaying contents based on seamless information in accordance with an exemplary embodiment includes a device database (DB) 210, a user device management unit 211, a content database (DB) 220, a content management unit 221, a seamless information database (DB) 230, a seamless information generation unit 231, a controller 240, and a device communication unit 250.

The device database (DB) 210 stores information about the plurality of devices 300 retained by a user. Here, the information about the plurality of devices 300 retained by the user is identification information to identify the devices and may include unique numbers, types, manufacturers, or other information about the devices. The device database 210 may store the information about the plurality of devices 300 retained by the user while classifying the information by users.

The user device management unit 211 manages information about the user and the information about the plurality of devices 300 retained by the user. The user device management unit 211 may also receive necessary information from the device database 210 and manage the received information.

Here, the information about the user may include identification information to identify the user. For example, in order to manage the information about the user, the user device management unit 211 may generate a user ID. By using the user ID, the user device management unit 211 may store the information about the plurality of devices 300 retained by the user in the device database 210 while classifying the devices 300 by users. That is, the devices 300 are linked to their respective users by the user device management unit 211.

Also, because the user device management unit 211 manages the information about the plurality of devices 300 while classifying the devices by their respective users, when there is an attempt to update the seamless information about the multimedia contents, the user device management unit 211 may choose only the corresponding device that wants to update the seamless information about the multimedia contents among the plurality of devices.

The content database 220 may store information about the multimedia contents retained by the user. The content database 220 may also store information about multimedia contents further purchased by the user. If there is a change in the information about the contents, the content database 220 may update the information by storing related information in cooperation with the content management unit 221, which is described below.

The content management unit 221 manages the information about the multimedia contents retained by the user. The content management unit 221 may manage the information about the retained multimedia contents while classifying the information by users. The content management unit 221 may also receive information about further purchased multimedia contents from the plurality of devices 300 to update the content database 220.

The seamless information database 230 stores seamless information about the multimedia contents. The seamless information database 230 may store seamless information generated from the seamless information generation unit 231. Here, the seamless information about the multimedia contents may include at least one of identification information of the multimedia contents, stop information which indicates a point at which the user stopped watching the multimedia contents, and setting information of the multimedia contents. The setting information of the multimedia contents may include additional information for the multimedia contents.

The seamless information generation unit 231 generates the seamless information about the multimedia contents. The seamless information generation unit 231 may generate the seamless information about the multimedia contents based on the display history information about the multimedia contents received from one of the plurality of devices 300 retained by the user. Here, the display history information about the multimedia contents may include various information related to the multimedia contents which is changed or additionally generated information when the display of the multimedia contents is stopped.

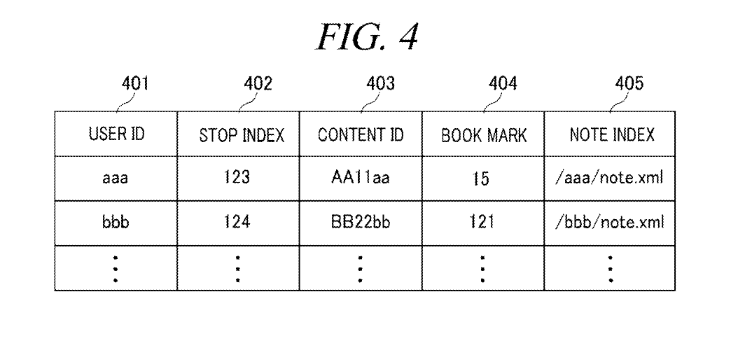

An example for management of the seamless information about the multimedia contents will be described later with respect to FIG. 4.

When the device of the user stops display of the multimedia contents, the controller 240 controls the user device management unit 211, the content management unit 221, and the seamless information generation unit 231 to generate seamless information based on the display history information of the multimedia contents received from a device of the user, and controls the device communication unit 250 to transmit the generated seamless information to the plurality of devices 300.

The device communication unit 250 executes communication with the plurality of devices 300 and receives or transmits various information to and from the devices 300. The device communication unit 250 may transmit the information about the multimedia contents and the seamless information to the plurality of devices 300. Also, the device communication unit 250 may receive the display history information of the multimedia contents from the plurality of devices 300.

If the seamless information has not been transmitted to at least one of the plurality of devices, the device communication unit 250 may periodically transmit the seamless information until the seamless information is transmitted to the one of the device.

If a device, which has not received the seamless information, is connected to the network 400, the content server 200 compares seamless information in the device with the seamless information in the content server 200 to determine whether the seamless information in the device has been updated or not. If seamless information in the device has not been updated, the device communication unit 250 may transmit the seamless information to the device.

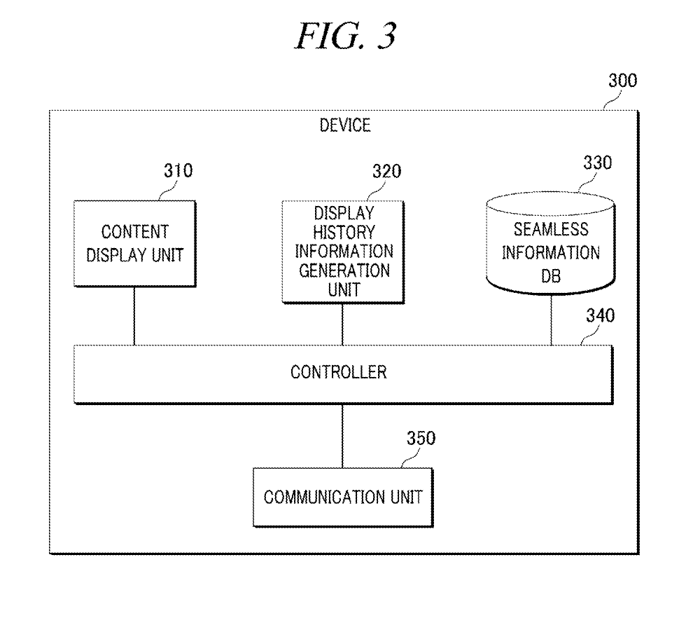

FIG. 3 is a configuration view illustrating a configuration of a device for displaying contents based on seamless information in accordance with an exemplary embodiment.

With reference to FIG. 3, the devices 300 for displaying contents based on seamless information in accordance with an exemplary embodiment includes a content display unit 310, a display history information generation unit 320, a seamless information database (DB) 330, a controller 340, and a communication unit 350.

The content display unit 310 displays one of a plurality of multimedia contents retained by a user. The content display unit 310 may obtain a selection of the multimedia contents requested by the user among the plurality of multimedia contents retained by the user, and display the multimedia contents on the content display unit 310 i.e., a display screen of a device.

Also, the content display unit 310 may display multimedia contents based on seamless information matched by the controller 340, which will be described later.

When the display of the multimedia contents is stopped, the display history information generation unit 320 generates display history information of the multimedia contents. The display history information generation unit 320 may also generate display history information of the multimedia contents including stop information which indicates a location in the multimedia contents where the user has stopped.

The seamless information database 330 stores the seamless information about the multimedia contents. The seamless information database 330 may store the seamless information about the multimedia contents received from the content server 200.

The controller 340 may match seamless information with multimedia contents.

The communication unit 350 executes communication with the server for displaying the multimedia contents based on seamless information. The communication unit 350 may transmit the display history information generated by the display history information generation unit 320 to the content sever 200, and receive the seamless information about the multimedia contents from the content server 200.

FIG. 4 is a view illustrating a table for managing seamless information about multimedia contents in a system for displaying contents based on seamless information in accordance with an exemplary embodiment.

The content server 200 may manage the seamless information about the multimedia contents using a seamless information table illustrated in FIG. 4. For example, FIG. 4 describes seamless information about electronic book contents.

The seamless information table for the electronic book contents may include a user ID 401, a stop index 402, a content ID 403, a book mark 404, a note index 405, and so on. Here, the user ID 401 is information to identify each user such as “aaa” identifying the first user, “bbb” identifying the second user. However, the present disclosure is not limited to a user ID.

The stop index 402 is an index for a corresponding page when the display of the contents is stopped. The stop index may list the multimedia contents in an order of specific numbers or characters by way of an example. FIG. 4 uses serial numbers such as stopped on page 123, stopped on page 124 and so on.

The content ID 403 is information to identify the multimedia contents retained by the user such as “AA11aa” or “BB22bb”. The book mark 404 is a marker to indicate a page that the user wants to memorize during the reading of the electronic book contents. The note index 405 refers to the identification information required when the user makes and stores a memo during the reading of the electronic book contents.

For example, when the device 301 stops the display of the electronic book contents, the seamless information table can be generated and/or updated and then stored. The table may include the following information:

First, the user can be stored with the user ID 401 ‘aaa’ that identifies the user. The stop index 402 can be stored with ‘123’ that indicates a corresponding page or the number of the corresponding pages in case of the electronic book contents. Content ID 403 of the displayed electronic book contents is ‘AA11aa’. ‘15’, which is a page that the user wants to memorize, which can be stored under the book mark 404. A memo written by the user can be stored as ‘/aaa/note.xml’ under the note index 405.

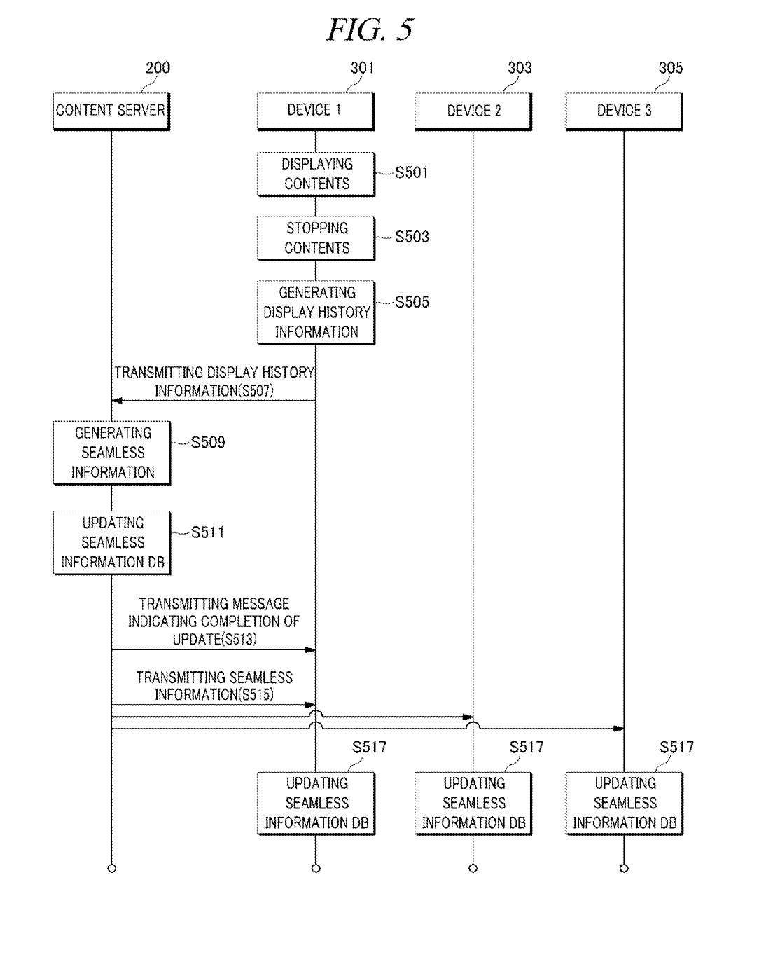

FIG. 5 is a flow chart illustrating a method of displaying contents based on seamless information in accordance with an exemplary embodiment.

With reference to FIG. 5, in operation S501, the device 301 displays multimedia contents. In operation S503, the device 301 stops the display of the multimedia contents.

In operation S505, the device 301 generates the display history information of the multimedia contents. In this case, the display history information of the multimedia contents may include stop information or additional information which is generated or changed when the display of the multimedia contents is stopped.

In operation S507, the device 301 transmits the generated display history information of the multimedia contents to the content server 200.

In operation S509, based on the transmitted display history information from the device 301, the content server 200 generates seamless information about the multimedia contents. That is, the content server 200 generates the seamless information by using the stop information indicating a location of the stopping the display of the multimedia contents included in the display history information.

In operation S511, the content server 200 updates seamless information by storing the generated seamless information about the multimedia contents in the seamless information DB. If the seamless information about the multimedia content for this user already exists in the seamless information DB, then it is updated. If the seamless information about the multimedia content for this user does not exist, then new seamless information is generated.

In operation S513, the content server 200 transmits a message indicating the completion of the update and/or generation of the seamless information about the multimedia contents to the device 301.

In operation S515, the content server 200 transmits the seamless information about the multimedia contents to the device 301 and other user devices 303 and 305. Once the seamless information is generated/updated by the content server 200, the updated seamless information can be broadcast to all registered devices and the devices distinguish the broadcast messages based on the user identifier. If the user identifier is determined to identify the user of the device, the device processes the broadcast message and updates the seamless information DB, as described below. On the other hand, if the user identifier is not known by the device i.e., is determined not to identify the user of the device, then the message is ignored by the device.

In yet another exemplary embodiment, the content server 200 identifies the user based on the transmitted history information. The content server 200 may search the device DB to determine all devices that are linked to the identified user. The content server 200 may then transmit the generated/updated seamless information to the determined devices.

In operation S517, the devices 301, 303 and 305 update the seamless information database 330 based on the transmitted seamless information.

Thereafter, the devices 301, 303 and 305 can receive the request for displaying the multimedia contents, and one of the devices displays the multimedia contents from a time point, at which the reproduction of the video contents is stopped on the device 301 by using the seamless information updated in operation S517.

The exemplary embodiments may be embodied in a transitory or non-transitory storage medium which includes instruction codes which are executable by a computer or processor, such as a program module which is executable by the computer or processor. A data structure in accordance with the exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of the exemplary embodiments is provided for the purpose of illustration, and it will be understood by those skilled in the art that various changes and modifications may be made without changing a technical conception and/or any essential features of the exemplary embodiments. Thus, the above-described exemplary embodiments are exemplary in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of the exemplary embodiments. It shall be understood that all modifications and embodiments conceived from the meaning and scope of the claims and their equivalents are included in the scope of the present inventive concept.

What is claimed is:

1. A method of providing a seamless multimedia contents service, the method comprising:
receiving by a content server, from one of a plurality of devices, display history information related to multimedia contents comprising stop information indicating a stop location in the multimedia contents;
generating seamless information about the multimedia contents based on the display history information; and
transmitting the generated seamless information to at least one of the plurality of devices;
wherein the at least one of the plurality of devices that received the transmitted seamless information, stores the seamless information, and
wherein the at least one of the plurality of devices displays the multimedia contents based on the stored seamless information.

2. The method of claim 1, wherein the seamless information comprises at least one of identification information of the multimedia contents, the stop information of the multimedia contents, and setting information of the multimedia contents.

3. The method of claim 1, wherein the setting information of the multimedia contents comprises additional information regarding the multimedia contents, wherein the additional information is input by a user.

4. The method of claim 1, wherein the transmitting the generated seamless information comprises if one device of the plurality of devices is not connected to the content server, the content server periodically transmits the seamless information to the one device until the seamless information is transmitted to the one device.

5. A content server for providing a seamless service of multimedia contents, the content server comprising:
a user device management unit configured to manage information on a user and information on a plurality of devices that belong to the user;
a content management unit configured to manage information on multimedia contents obtained by the user;
a seamless information generation unit configured to generate seamless information about the multimedia contents based on display history information comprising stop information indicating a stop location in the multimedia contents received from one of the plurality of devices; and
a device communication unit configured to transmit the seamless information to the plurality of devices and configured to receive the display history information from the one of the plurality of devices,
wherein the seamless information is stored in the plurality of devices, and
wherein one of the plurality of devices displays the multimedia contents based on the stored seamless information.

6. The server of claim 5, wherein the seamless information comprises at least one of identification information of the multimedia contents, the stop information of the multimedia contents, and setting information of the multimedia contents.

7. The server of claim 5, wherein, if the seamless information has not been transmitted to one device of the plurality of devices, the device communication unit periodically transmits the seamless information to the one device until the seamless information is transmitted to the one device.

8. A device for displaying multimedia contents, the device comprising:
a content display unit configured to display one of a plurality of multimedia contents obtained by a user;
a display history information generation unit configured to generate display history information of the multimedia contents based on a stopped location in displaying of the multimedia contents;
a communication unit configured to transmit the generated display history information to a content server and configured to receive seamless information from the content server; and
a controller configured to match the seamless information with the multimedia contents,
wherein the content display unit displays the multimedia contents based on the seamless information received by the communication unit.

9. The device of claim 8, wherein the seamless information comprises at least one of identification information of the multimedia contents, the stop information of the multimedia contents, and setting information of the multimedia contents,
wherein the setting information of the multimedia contents comprises additional information regarding the multimedia contents, and
wherein the additional information is input by a user.

10. The method of claim 1, wherein the seamless information further comprises a user identification and at least one of a memo and a book mark.

11. The method of claim 1, further comprising determining devices from the plurality of devices that belong to a user based on the received display history information and transmitting the generated seamless information to each of the determined devices.

12. A method of displaying multimedia contents, the method comprising:
displaying the multimedia contents;
stopping the displaying of the multimedia contents;
determining a position of the stopping in the multimedia contents;
generating display history information comprising identification of the multimedia content displayed, the stopping position;
transmitting the history information and an identification of a user to a server;
receiving from the server seamless information; and
resuming display of the multimedia contents from the stopped position based on the received seamless information without having network connectivity.

13. The method of claim 12, wherein the seamless information comprises identification of a user, identification of the multimedia contents, and the stop position.

14. The method of claim 13, wherein the seamless information comprises setting information.

15. The method of claim 12, further comprising:
determining by the server a device that transmitted the display history information;
determining by the server at least one other device that belongs to the user based on the received user information; and
transmitting by the server the seamless information to the at least one other device.

16. The method of claim 15, wherein the resuming the display comprises resuming the display of the multimedia content from the stopped position by the other device without having connectivity to the server.
